(19) United States
(12) Patent Application Publication
(10) Pub. No.: US 2001/0053464 A1
(43) Pub. Date: Dec. 20, 2001

(54) Telecommunication apparatus having electromagnetic wave absorbing device

(76) Inventor: Chang Ho Ra, Buchon- City (KR)

Correspondence Address: LEE & HONG, 11th Floor, 221 N. Figueroa Street, Los Angeles, CA, 90012, US

(21) Appl. No.: 09/771,376

(22) Filed: Jan. 26, 2001

(30) Foreign Application Priority Data
Mar. 9, 2000 (KR) 2000-6712
Jan. 28, 2000 (KR) 2000-4402

(51) Int. Cl. C04B 35/26; C04B 35/64

(52) U.S. Cl. 428/692; 252/62.56

(57) ABSTRACT

A mobile telecommunication apparatus comprises a front cover defining a display opening, wherein the front cover includes a front and rear surface; and at least one electromagnetic energy absorbing ferrite disposed near the rear surface and display opening of the front cover, wherein the ferrite comprises about 80 to 85 wt. % of Fe₂O₃, about 9 to 15 wt. % of MnO₂, about 8 to 10 wt. % of ZnO and 1 to 3 wt. % of SiO₂. Preferably, four ferrites are attached to the rear surface of the front cover near each corner of the display opening. Each ferrite has a weight of about 0.1 to 0.3 grams, and preferably, about 0.2 grams.

### CROSS REFERENCE TO RELATED ART

This application claims the benefit of Korean Patent Application Nos. 2000-6712 and 2000-4402, filed respectively on Mar. 9, 2000 and Jan. 28, 2000, which are hereby incorporated by reference.

### BACKGROUND OF THE INVENTION

1. Field of the Invention

The present invention relates to a mobile telecommunication apparatus, and more particularly, to a mobile telecommunication apparatus having electromagnetic wave absorbing material to reduce emission of electromagnetic wave.

2. Discussion of the Related Art

Many electric devices such as cellular phones, beepers, computers, wireless telephones, televisions etc., are utilized during daily life. It is necessary to use these electric devices in modern daily life, but most of these devices radiate electromagnetic waves. It is well known to everybody that the electromagnetic waves generated from these electric devices are harmful to people who use these electric devices.

Users of mobile telecommunication devices, such as cellular phones, are exposed to harmful electromagnetic waves without any awareness because such waves have no smell and are invisible. Due to the structure of mobile phones, users should closely place their ears to the speaker (receiver) of the phones during communication. According to the studies by scientists, electromagnetic waves generated from a mobile phone are not harmful to the human body if the user communicates for a short time or takes enough rest before the next communication. However, they warn that electromagnetic waves will greatly affect the brain of the user if the user continuously uses a mobile phone for a long time without rest.

It has been generally believed that harmful electromagnetic waves are generated from an antenna of portable telecommunication devices, such as mobile phones. According to the recent studies, however, the liquid crystal display region of such telecommunication devices emits stronger electromagnetic waves than those generated from the antenna because such region cannot be shielded because of the opening created for the display. In addition, conventional electromagnetic wave adsorptive devices have generally been attached to the outside of mobile phones, which goes against the current tendency to pursue aesthetical qualities.

Research for shielding the harmful electromagnetic waves generated from these electric devices is being continued. Pellets for making electromagnetic waves shielding material are disclosed in U.S. Pat. No. 4,960,642 (issued to Izumi Kosuga et. al). The pellets can shield electromagnetic waves by inserting conductive fibers into a matrix resin. Also, a method for absorbing electromagnetic waves generated from electric devices by means of installing a ferrite core into these electric devices is disclosed.

However, above-described pellets and method cannot block enough of the electromagnetic waves generated from these electric devices, and the manufacturing method and the structure of these devices are complicated because the pellets and the magnetic core are inserted on the circuit board of the electromagnetic devices.

New applications for fine ceramics such as thermal applications, mechanical applications, bio-chemical applications, electric applications, electronic applications, and optic applications are being discovered, and the research concerning these applications will be continued. It particular, it has been discovered that some ceramic materials have electromagnetic wave absorbing characteristics.

Generally, fine ceramics are different from conventional ceramics in their composition and their manufacturing method such as forming and sintering. Fine ceramics are generally classified into oxide type ceramics and non-oxide type ceramics. An oxide type ceramic includes alumina (Al₂O₃), ferrite (Fe₂O₃), zirconia (ZrO₂), and titania (TiO₂) etc. A non-oxide type ceramic includes silicon carbide (SiC), and silicon nitride (Si₃N₄) and so on.

Fine ceramics are manufactured by a forming method and a sintering method which exactly control a precisely prepared composition by using an artificial raw powder or a highly purified raw powder. Thus, fine ceramics have a greater number of applications than conventional ceramics. Fine ceramics are used for various purposes because various applications of fine ceramics have recently been discovered.

### SUMMARY OF THE INVENTION

Accordingly, the present invention is directed to a mobile telecommunication apparatus, such as a mobile telephone that substantially obviates one or more of the problems due to limitations and disadvantages of the related art.

It is an object of the present invention to provide a telecommunication apparatus that protects the user from exposure to harmful electromagnetic waves during communication.

It is another object of the present invention to provide ways to prevent electromagnetic wave from eminating through the unshielded display opening region.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a mobile telecommunication apparatus comprises a front cover defining a display opening, wherein the front cover includes a front and rear surface; and at least one electromagnetic energy absorbing ferrite disposed near the rear surface and display opening of the front cover, wherein the ferrite comprises about 80 to 85 wt. % of Fe₂O₃, about 9 to 15 wt. % of MnO₂, about 8 to 10 wt. % of ZnO and 1 to 3 wt. % of SiO₂.

According to one aspect of the present invention, a plurality of ferrites attached to the rear surface of the front cover, around edges of the display opening. Preferably, four ferrites are attached to the rear surface of the front cover near each corner of the display opening.

According to another aspect of the present invention, the ferrite has a substantially cylindrical shape. The ferrite has a weight of about 0.1 to 0.3 grams, and preferably, about 0.2 grams.

The ferrite is manufactured by the process comprising the steps of: mixing about 80 to 85 wt. % of Fe₂O₃, about 9 to 15 wt. % of MnO₂, about 8 to 10 wt. % of ZnO and 1 to 3 wt. % of SiO₂ to form a major component mixture; spray drying the mixture; mixing about 3 to 3.5 wt. % of CuO, about 2.5 to 5 wt. % of CaO, about 2.5 to 4 wt. % of CoO, about 1.5 to 2.0 wt. % of MoO and about 0.2 to 0.5 wt. % of Y₂O₃, to form a minor component mixture; mixing the major and the minor mixtures to form a composite mixture; spray drying the composite mixture to obtain granule powder; placing the powder into a mold of a desired shape, and compressing the powder under a pressure between about 1200 kg/cm² and 1500 kg/cm²; heating the molded and compressed powder in a furnace, and heating the furnace for about 9 hours to a temperature of about 1420° C.; calcining the heated and compressed powder for about 4 hours in the furnace of about 1420° C., and slowly cooling the furnace to a temperature of about 200° C. to form a ferrite; introducing inert gas, such as nitrogen, into the furnace; and taking the ferrite out from the furnace when the temperature in the furnace drops to about 200° C. and cooling it at a room temperature.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 illustrates a front schematic view of a mobile telephone front cover assembly according to a preferred embodiment of the present invention;

FIG. 2 illustrates a rear schematic view of the mobile telephone front cover assembly showing one set of preferred locations of the EMW absorbing ferrites with respect to the display opening;

FIG. 3 illustrates the front cover of mobile telephone with two ferrites placed above the display opening;

FIG. 4A illustrates a top plan view of the ferrite according to a preferred embodiment of the present invention;

FIG. 4B illustrates a cross-sectional view of the ferrite shown in FIG. 3;

FIG. 4C illustrates a side elevational view of the ferrite shown in FIG. 3;

FIG. 4D illustrates a bottom plan view of the ferrite shown in FIG. 3; and

FIGS. 5A and 5B illustrate the effect of the ferrites on the performance of the mobile telephone.

### DETAILED DESCRIPTION OF THE PREFERRED EMBODIMENTS

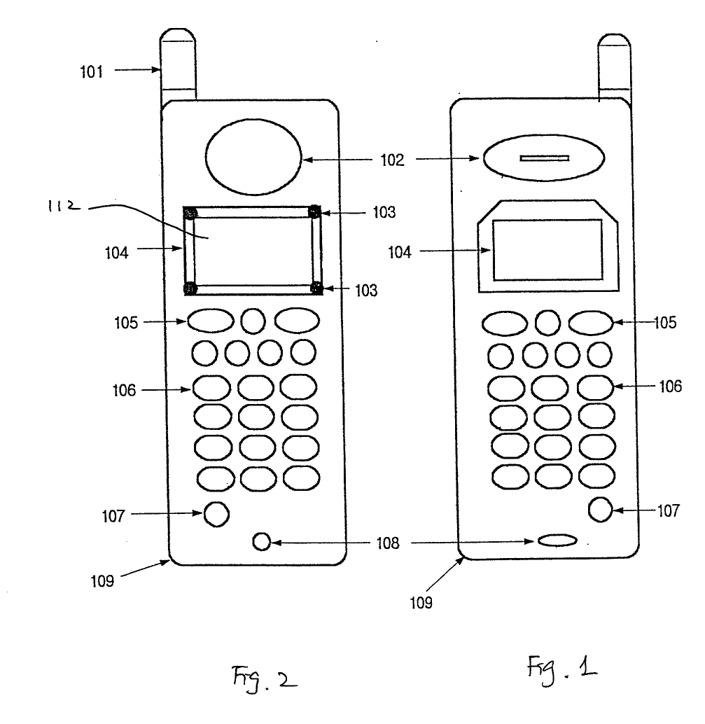

With reference to the drawings, and in particular to FIGS. 1-5B thereof, a mobile telecommunication apparatus having a electromagnetic wave absorbing device embodying the principles and concepts of the present invention will be described.

For purposes of illustration, a mobile telephone is described as an exemplar of the mobile telecommunication apparatus without limiting the application of the present invention.

Referring to FIGS. 1 and 2, a schematical diagram of a mobile telephone according to a preferred embodiment of the present invention is shown. The mobile telephone generally comprises a housing 109, an antenna protruding from the top of the housing 101, a key pad 106, an ear piece 102 for receiving voice signal and a mouthpiece 108 for transmitting voice data. According to the preferred embodiment, a plurality of eletromagnetic energy absorbing ceramics or ferrites 103 are used around four corners of a display opening 112 for a liquid crystal display. For purposes of describing the present invention, the terms ceramic and ferrite are being used interchangeably. In addition, the term electromagnetic energy encompasses electromagnetic field, electromagnetic wave and other forms of electromagnetic transmission.

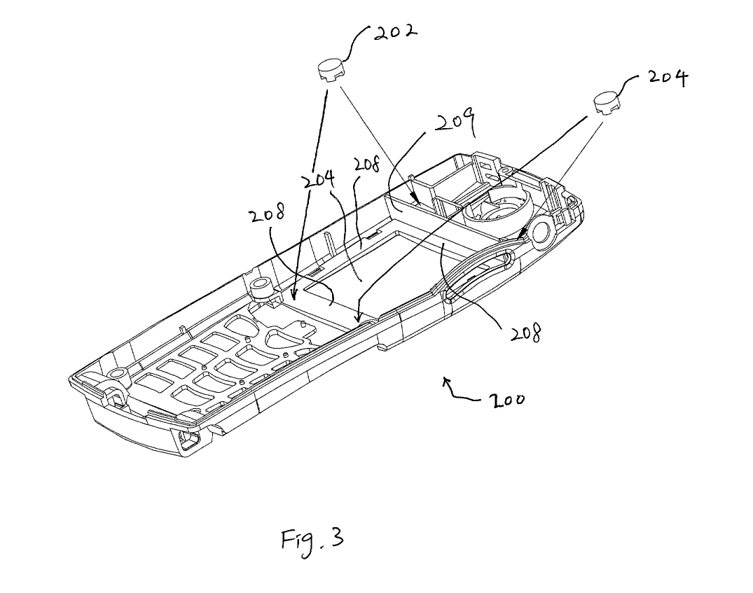

FIG. 3 illustrates a front cover 200 of mobile telephone with two ferrites 202 and 204 placed above the display opening 204. The ferrites 202 and 204 are positioned around the opening 204 to absorb electromagnetic wave or field leaking through the opening 204. Because the human ear is usually pressed against the liquid crystal display of the mobile telephone, the amount of electromagnetic wave leaking through this region is substantially greater than through the coated housing of the mobile telephone.

Although it is preferable that the ferrites are attached to the four corner of the display opening 204, sometime there may not be a sufficient space to place them. In such case, the ferrites may be place any available positions near the opening that do not interfere with the location of the internal components. For example, as shown in FIG. 3, the ferrites 202, 204 may be placed above a partition 209 but below the ear piece.

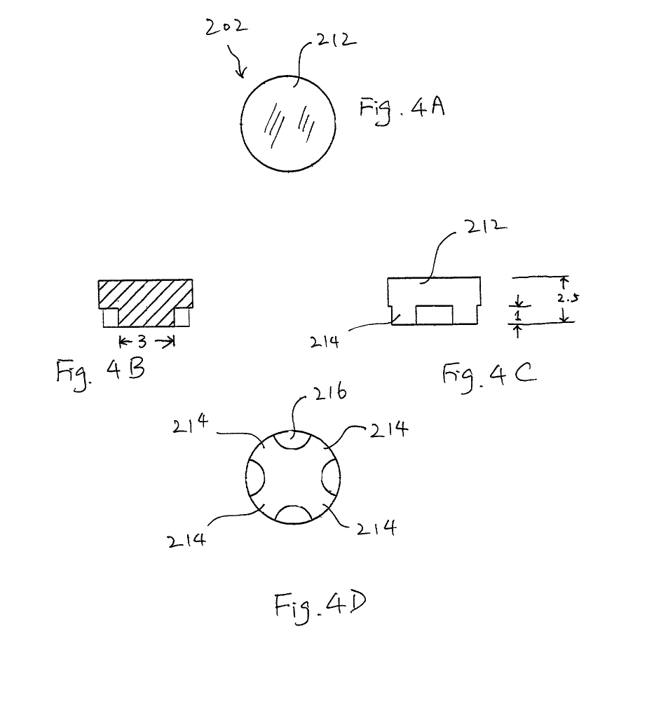

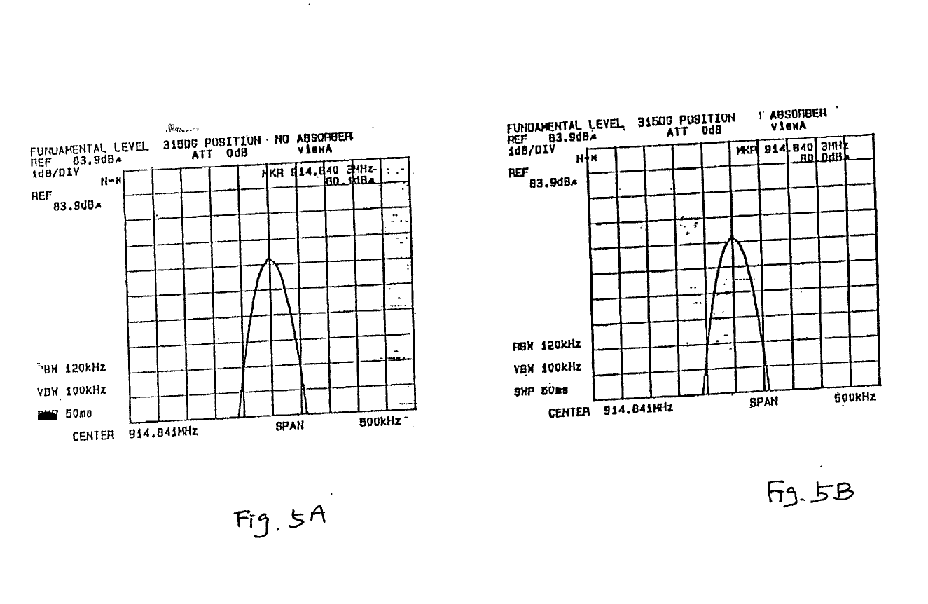

FIGS. 4A-4D illustrate a ferrite 202 as used in the present invention. In particular, FIG. 4A illustrates a top plan view; FIG. 4B illustrates a cross-sectional view; FIG. 4C illustrates a side elevational view; and FIG. 4D illustrates a bottom plan view of the ferrite 202. According to the preferred embodiment, the ferrite 202 includes a top plate 212 and four supports 214 extending therefrom. In particular, the four supports 214 are formed by creating partially circular indents 216 at the lower portion of the ferrite 202.

According to the preferred embodiment, the ferrite 202 has the following preferred dimensions. The total thickness of the ferrite 202 is about 2.5 mm. The supports 214 have a thickness of about 1 mm. The top plate has a diameter of about 5 mm. Alternatively, the ferrite 202 may take any form and shape so long as it can be fitted near the edges of the opening for the liquid crystal display. For example, the ferrite may be molded in a shape of a thin elongated strip to be attached to the inner edges 208 of the display opening 204, shown in FIG. 3. Instead of a single long strip, a plurality of short strips may also be used around the circumference of the display opening.

In the preferred embodiment, each ferrites 202, 204 is made of a material described below. Also, the rate and the amount of absorbability are related to the shape and weight of the ferrite. Preferably, each ferrite 202 is approximately 0.1 g to 0.3 g, and preferably about 0.2 g. However, the heavier or lighter ferrites may be used near the display opening of the face plate without deviating from the gist of the present invention.

Although FIG. 2 illustrates a front cover that uses two ferrites 202 and 204, as more ferrites are used around the opening 204, more electromagnetic wave is absorbed. Moreover, although two identically shaped ferrites 202, 204 are used for purposes of illustration in FIG. 3, ferrites having different shapes and weights may be used in the same mobile telephone, with heavier ferrites preferably used closer to the RF generating source, such as an antenna.

The procedure for preparing the ferrite will now be described. According to the present invention, a composition for use in an electromagnetic wave adsorbent or ferrite preferably comprises 80 to 85 wt. % of Fe₂O₃, 9 to 15 wt. % of MnO₂, 8 to 10 wt. % of ZnO and 1 to 3 wt. % of SiO₂, as main components for effectively adsorbing electromagnetic waves having a radio frequency ranging from 800 MHz to 900 MHz, and 3 to 3.5 wt. % of CuO, 2.5 to 5 wt. % of CaO, 2.5 to 4 wt. % of CoO, 1.5 to 2.0 wt. % of MnO₃ and 0.2 to 0.5 wt-% of Y₂O₃ as minor components. These main and minor components are mixed and spray dried until they become granule powder. The powder is inserted into a mold of a desired shape, and compressed under a pressure between 1200 kg/cm² and 1500 kg/cm².

The composition obtained by the above process is placed within a calcining furnace. The furnace is slowly heated for 9 hours until it reaches 1420° C. The composition is calcined for about 4 hours in the furnace of 1420° C. Then, the furnace is slowly cooled until it drops to 200° C. It is preferble to perform the calcination under nitrogen atmosphere. When the temperature in the furnace becomes approximately 200° C., the calcined electromagnetic wave adsorbing ceramic or ferrite is taken out from the furnace and slowly cooled at room temperature.

More particularly, to obtain a composition for effectively adsorbing electromagnetic waves of radio frequency ranging from about 800 MHz to 900 MHz, 80 wt. % of Fe₂O₃, 15 wt. % of MnO₂, 10 wt. % of ZnO and 3 wt. % of SiO₂, which are main components of the composition, are mixed and spray dried. Subsequently, 3.5 wt. % of CuO, 5 wt. % of CaO, 4 wt. % of CoO, 2.0 wt. % of MoO and 0.5 wt. % of Y₂O₃, which are minor components, are mixed with the main components and spray dried once more to obtain granule powder. The powder is inserted into a mold of a desired shape, and compressed under a pressure between 1200 kg/cm² and 1500 kg/cm². The molded powder is placed within a calcining furnace. The furnace is slowly heated for 9 hours until it reaches 1420° C. The heated powder is calcined for about 4 hours under nitrogen atmosphere. Then, the furnace is slowly cooled until it drops to 200° C. When the temperature in the furnace becomes 200° C., the calcined one (adsorbent) is taken out from the furnace and slowly cooled at room temperature.

According to the preferred embodiment of the present invention, the EMW absorbing ferrite has no substantial affect in the transmission and reception of radio signals from and to a mobile telephone. As shown in FIGS. 5A and SB, according to laboratory experiments on the influence of the electromagnetic wave adsorbent on the transmission/receiving radio waves of a mobile telephone, no substantial deterioration has been detected. FIG. 5A illustrates a power level of the mobile telephone antenna without the ferrites, whereas FIG. 5B illustrates with the ferrites on top corners of the display opening. As shown, the power graphs are substantially identical and show no performance degradation to each telephone.

Additional tests have been performed to measure the Specific Absorption Rate (SAR). The SAR measures the amount of radio frequency (RF) power absorbed in any part of human body due to the use of equipment generating electromagnetic wave or field, such as mobile telephones, or due to the exposure to other transmitting sources. The SAR is the time rate at which RF energy is imparted to a unit mass of a biological body. In SI (international system of units of measurement) units, SAR is commonly expressed in W/kg (watt per kg).

The SAR measurement tests were conducted using two different mobile telephones, namely Types A and B. Type A telephone was equipped with a shielded housing (for example, coating the housing with a conductive material) without the ferrites. Type B telephone was equipped with a shielded housing with two ferrites located as shown in FIG. 3. Both telephones are tri-mode PCS type telephones. For both types, the inner surface of the housing was coated with a conductive material to shield electromagnetic energy from escaping through the housing body.

The result is as follows:

| Type | Frequency (MHz) | Max 1 g SAR (W/kg) |
|---|---|---|
| Type A | 1910 | 0.763 |
| Type A | 1880 | 0.704 |
| Type A | 1850 | 0.462 |
| Type B | 1910 | 0.702 |
| Type B | 1880 | 0.418 |
| Type B | 1850 | 0.42 |

In the above table Max 1 g SAR means the amount of maximum RF energy absorbed by 1 gram of human tissue.

As shown above, Type B telephone equipped with the ferrites showed drastic decrease in the SAR measurement. This translates to less RF energy absorbed by human tissue. As more ferrites are used in the mobile telephones, the SAR numbers can be further reduced.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A mobile telecommunication apparatus comprising:
a front cover defining a display opening, wherein the front cover includes a front and rear surface; and
at least one electromagnetic energy absorbing ferrite disposed near the rear surface and display opening of the front cover, wherein the ferrite comprises about 80 to 85 wt. % of Fe₂O₃, about 9 to 15 wt. % of MnO₂, about 8 to 10 wt. % of ZnO and 1 to 3 wt. % of SiO₂.

2. The mobile telecommunication apparatus of claim 1, further comprising a plurality of ferrites attached to the rear surface of the front cover, around edges of the display opening.

3. The mobile telecommunication apparatus of claim 2, wherein four ferrites are attached to the rear surface of the front cover near each corner of the display opening.

4. The mobile telecommunication apparatus of claim 1, wherein the ferrite has a substantially cylindrical shape.

5. The mobile telecommunication apparatus of claim 1, wherein the ferrite has a weight of about 0.1 to 0.3 grams.

6. The mobile telecommunication apparatus of claim 1, wherein the ferrite has a weight of about 0.2 grams.

7. The mobile telecommunication apparatus of claim 3, wherein each ferrite has a weight of about 0.2 grams.

8. The mobile telecommunication apparatus of claim 1, wherein the ferrite further comprises about 3 to 3.5 wt. % of CuO, about 2.5 to 5 wt. % of CaO, about 2.5 to 4 wt. % of CoO, about 1.5 to 2.0 wt. % of MoO and about 0.2 to 0.5 wt. % Of Y₂O₃.

9. The mobile telecommunication apparatus of claim 8, further comprising a plurality of ferrites attached to the rear surface of the front cover, around edges of the display opening.

10. The mobile telecommunication apparatus of claim 9, wherein four ferrites are attached to the rear surface of the front cover near each corner of the display opening.

11. The mobile telecommunication apparatus of claim 8, wherein the ferrite has a substantially cylindrical shape.

12. The mobile telecommunication apparatus of claim 8, wherein the ferrite has a weight of about 0.1 to 0.3 grams.

13. The mobile telecommunication apparatus of claim 8, wherein the ferrite has a weight of about 0.2 grams.

14. The mobile telecommunication apparatus of claim 1, wherein the ferrite is formed by the steps comprising:
mixing about 80 to 85 wt. % of Fe₂O₃, about 9 to 15 wt. % of MnO₂, about 8 to 10 wt. % of ZnO and 1 to 3 wt. % of SiO₂ to form a major component mixture;
drying the mixture;
mixing about 3 to 3.5 wt. % of CuO, about 2.5 to 5 wt. % of CaO, about 2.5 to 4 wt. % of CoO, about 1.5 to 2.0 wt. % of MoO and about 0.2 to 0.5 wt. % of Y₂O₃, to form a minor component mixture;
mixing the major and the minor mixtures to form a composite mixture;
drying the composite mixture to obtain powder;
placing the powder into a mold of a desired shape, and compressing the powder;
heating the molded and compressed powder in a furnace;
calcining the heated and compressed powder for about 4 hours in the furnace of about 1420° C., and slowly cooling the furnace to a temperature of about 200° C. to form a ferrite;
introducing inert gas into the furnace; and
cooling the ferrite.

15. The mobile telecommunication apparatus of claim 14, wherein the compression of the powder is performed under a pressure between about 1200 kg/cm² and about 1500 kg/cm².

16. The mobile telecommunication apparatus of claim 14, wherein the powder in the furnace is heated at a temperature of about 1420° C.

17. The mobile telecommunication apparatus of claim 16, wherein the powder in the furnace is heated for about 9 hours to a temperature of about 1420° C.

18. The mobile telecommunication apparatus of claim 14, wherein the inert gas is nitrogen.

19. The mobile telecommunication apparatus of claim 14, wherein the cooling of the ferrite is by taking the ferrite out from the furnace when the temperature in the furnace drops to about 200° C.

20. The mobile telecommunication apparatus of claim 19, wherein the ferrite is cooled at a room temperature.
